(19) United States
(12) Patent Application Publication
(10) Pub. No.: US 2026/0158377 A1
(43) Pub. Date: Jun. 11, 2026

(54) GAME SYSTEM AND METHOD FOR PROVIDING EVENTS BASED ON LOCATION COORDINATE VALUES, COMPUTER-READABLE RECORDING MEDIUM STORING A PROGRAM FOR EXECUTING A METHOD

(71) Applicant: FUNNY STORM, Seongnam-si (KR)

(72) Inventors: Chunggil YU, Suwon-si (KR); Il Hoon JUNG, Seongnam-si (KR); Jin Hong PARK, Seongnam-si (KR); Jeong-Hwan IM, Hanam-si (KR)

(21) Appl. No.: 19/416,550

(22) Filed: Dec. 11, 2025

(30) Foreign Application Priority Data
Dec. 11, 2024 (KR) 10-2024-0184047

(51) Int. Cl. A63F 13/35; A63F 13/216

(52) U.S. Cl. CPC A63F 13/35; A63F 13/216

(57) ABSTRACT

The present invention relates to a location coordinate value-based event providing game system and method, and a computer-readable recording medium storing a program for executing the method, which provides a client program for executing a location-based game to a connected client terminal, generates an event table including an event rule, and causes a corresponding event to be executed in the client terminal when matched with the event rule during game execution, wherein the event rule sets a coordinate keyword according to a combination rule between numbers at designated digits of location coordinate values, and generates the corresponding event when a combination result between numbers at designated digits of current location coordinate values of the client terminal matches the set coordinate keyword. Since an event coverage range and an event target rule are freely set by utilizing location coordinate values, contingency and randomness of event occurrence can be increased.

### CROSS-REFERENCE TO RELATED APPLICATION

This application claims priority to and the benefit of Korean Patent Application No. 10-2024-0184047 filed with the Korean Intellectual Property Office on Dec. 11, 2024, the entire contents of which are incorporated herein by reference.

### BACKGROUND OF THE INVENTION

### (a) Field of the Invention

The present invention relates to a technique for providing an event based on location coordinate values of a user in a location-based game.

### (b) Description of the Related Art

Generally, in a location-based game, a server generates various events designated for each specific location based on a user location and provides the events to a user.

In this case, based on geographic information of a user location provided by a map server, a game server provided a predetermined event for a designated place, that is, a corresponding point, or provided an event according to a point attribute.

In this case, since the game server manages both locations and times of events provided to a large number of users, there was a limitation in expanding the number or diversity of events that can be provided to each user in order to prevent excessive server load.

In addition, when a type of a game event is set based on a point information attribute of the real world, there is a possibility that places having the same point attribute are concentrated depending on regional characteristics. In this case, users have no choice but to repeatedly experience only the same events within a movement area, so there was a possibility of reducing user interest in the game events.

In addition, when events are provided according to a certain rule for each point, there was a possibility of similarly reducing user interest due to predictability of each event.

### SUMMARY OF THE INVENTION

Accordingly, a technical problem to be solved by the present invention is to expand the diversity of events provided to a user without an excessive increase in server load when providing a game event in a location-based game.

In addition, another technical problem to be solved by the present invention is to improve interest in the game by increasing chance and randomness from a user's perspective when providing a game event in a location-based game

Further, another technical problem to be solved by the present invention is to provide a new control means for a game event provided to users, and to enable free adjustment of a target area range or an occurrence time.

A game system for providing a location-based event according to an aspect of the present invention for solving the technical problem includes: a service server configured to receive and register member information of game service users from a client terminal and perform member management; and a game server configured to provide a client program for game play, generate an event table including an event rule, and cause a corresponding event to be executed in the client terminal when matched with the event rule during game execution, wherein the event rule is to set a coordinate keyword according to a combination rule between digits at designated places among location coordinate values, and generate the corresponding event when a combination result between digits at designated places among current location coordinate values of the client terminal matches the set coordinate keyword.

In this case, the event rule may further include a time variable, and an event matching coordinate keyword may be set for each predetermined time zone.

In addition, the location coordinate values may represent latitude and longitude values.

Further, the game server may include: a client program providing unit configured to provide the client program; an event table providing unit configured to generate an event table defining the event rule; a participation condition setting unit configured to set an event participation available condition for users; an event providing unit configured to provide corresponding event information to cause the event to be executed when a location of the client terminal corresponds to an event matching coordinate keyword and a corresponding user satisfies the event participation available condition; and a user event information management unit configured to store content of progress of the corresponding event and participation result information of the user.

In addition, the event table providing unit may provide the event table to the client terminal at predetermined time intervals to cause the client terminal to store the event table, check the event rule from the stored event table, and determine whether the corresponding event rule is matched.

Further, the event participation available condition may include one or more of a cumulative available participation count for the corresponding event per user, a daily available participation count per user, and a first-come-first-served available participant count per event.

Meanwhile, an event providing method of a location-based game providing system according to an aspect of the present invention for solving the technical problem comprising: a) providing a client program for location-based game execution to a connected client terminal; and b) generating an event table including an event rule, and causing a corresponding event to be executed in the client terminal when matched with the event rule during game execution, wherein the event rule is to set a coordinate keyword according to a combination rule between digits at designated places among location coordinate values, and generate the corresponding event when a combination result between digits at designated places among current location coordinate values of the client terminal matches the set coordinate keyword.

In this case, the event rule may further comprise a time variable, and an event matching coordinate keyword may be set for each predetermined time zone.

Further, the location coordinate values may represent latitude and longitude values.

In addition, step b) may further comprise a step of setting an event participation available condition for users, and may be a step of providing corresponding event information to cause the corresponding event to be executed when a location of the client terminal corresponds to an event matching coordinate keyword and the corresponding user satisfies the event participation available condition.

Further, the event participation available condition may comprise one or more of a cumulative available participation count for the corresponding event per user, a daily available participation count per user, and a first-come-first-served available participant count per event.

Further, after step b), the method may further comprise a step of storing content of progress of the corresponding event and participation result information of the user.

Meanwhile, step b) may further comprise a step of providing the event table to the client terminal to enable the client terminal to store the event table, check the event rule from the stored event table, and determine whether the corresponding event rule is matched.

In addition, a computer-readable recording medium according to an aspect of the present invention for solving the technical problem is a computer-readable recording medium storing a program for executing a method of providing an event in a location-based game, wherein the method comprises: a) a step of a device storing a client program for location-based game play, receiving player information, and executing a game; b) a step of the device receiving and storing an event table comprising an event rule from a location-based game system, determining whether the event rule is matched during game execution, and requesting a start of an event to the location-based game system when matched; and c) a step of receiving corresponding event progress information from the location-based game system and executing the event, wherein the event rule may be to set a coordinate keyword according to a combination rule between digits at designated places among location coordinate values, and generate the corresponding event when a combination result between digits at designated places among current location coordinate values of the device matches the set coordinate keyword.

In this case, the event rule may further comprise a time variable, and an event matching coordinate keyword may be set for each predetermined time zone.

Further, the location coordinate values may represent latitude and longitude values.

As described above, according to the present invention, by using the event table provided to the client terminal, it is possible to check event matching for each user through the client terminal without server load and proceed with the corresponding event.

In addition, according to the present invention, since an event coverage range and an event target rule are freely set by utilizing location coordinate values, it is possible to increase chance and randomness of event occurrence.

Further, according to the present invention, since an event rule is set by utilizing location coordinate values for event control and provided to a client terminal through an event table, an event target area, an area range, and an occurrence time can be diversely and easily controlled.

### BRIEF DESCRIPTION OF THE DRAWINGS

FIG. 1 is an overall configuration diagram including a game system for providing an event based on location coordinate values according to an aspect of the present invention.

FIG. 2 is a configuration diagram of a game server according to an aspect of the present invention.

FIG. 3A is an example of a table setting map point information of a corresponding area and event types based on point attributes, according to an aspect of the present invention.

FIG. 3B is a view illustrating point information for an event on map information of a corresponding area according to an aspect of the present invention.

FIG. 3C is a view illustrating event types displayed at respective points for an event in FIG. 3B according to an aspect of the present invention.

FIG. 3D is a view illustrating a method of generating a coordinate keyword by utilizing latitude and longitude values of a specific location according to an aspect of the present invention.

FIG. 3E is an example of an event table showing coordinate keywords for generating corresponding events for each time according to an aspect of the present invention.

FIGS. 4A and 4B are views illustrating event coordinate keywords and occurring events corresponding to time 1 and time 2, according to an aspect of the present invention.

FIGS. 5A to 5E are examples of event tables according to an aspect of the present invention, wherein monster skins, colors, equipment, and types are set by generating coordinate keywords utilizing latitude and longitude values of a specific location, the monster skins, colors, equipment, and types are varied according to days through an additional table, and coordinate keywords where monsters appear are included.

FIGS. 6A to 6D illustrate events for respective points, specific events, and examples of specific events occurring within a corresponding block after generating latitude and longitude coordinate blocks for generating events.

FIG. 7 is a configuration diagram of a client terminal according to an aspect of the present invention.

FIG. 8 schematically illustrates an overall process in which a location coordinate value-based event providing game system provides an event table including coordinate keywords according to a combination of latitude and longitude values, and an event is proceeded with at a client terminal when corresponding to an event rule, according to an aspect of the present invention.

FIG. 9 illustrates an overall flow in which a location-based event providing game system provides an event table to a client terminal and causes a corresponding event to be executed when corresponding to an event rule, according to an aspect of the present invention.

FIG. 10 illustrates an overall flow in which a client terminal checks whether an event rule is matched and executes an event, according to an aspect of the present invention.

### DETAILED DESCRIPTION OF THE EMBODIMENTS

In the following detailed description, only certain embodiments of the present invention have been shown and described, simply by way of illustration. However, the present invention may be implemented in various different forms and is not limited to the embodiments described herein. Accordingly, the drawings and description are to be regarded as illustrative in nature and not restrictive. Like reference numerals designate like elements throughout the specification.

In addition, unless explicitly described to the contrary, the words “include”, “comprise” and variations such as “includes”, “including” “comprises” or “comprising”, will be understood to imply the inclusion of stated elements but not the exclusion of any other elements.

In addition, terms such as ‘ . . . unit’, ‘ . . . device’, and ‘ . . . module’ described in the specification refer to a unit processing at least one function or operation, and may be implemented as hardware, software, or a combination of hardware and software.

The devices described in the present invention are configured as hardware comprising at least one processor, a memory device, a communication device, and the like, and a program executed in combination with the hardware is stored in a designated location. The hardware has a configuration and performance capable of executing the method of the present invention. The program includes instructions implementing the operation method of the present invention described with reference to the drawings, and executes the present invention in combination with hardware such as a processor and a memory device.

In the present specification, “transmission or provision” may include not only direct transmission or provision, but also indirect transmission or provision through another device or using a bypass path.

In the present specification, an expression described in the singular may be interpreted as singular or plural unless an explicit expression such as ‘one’ or ‘single’ is used.

In the present specification, the same reference numerals refer to the same components regardless of the drawings, and “and/or” includes each and every combination of one or more of the mentioned components.

In the present specification, terms including ordinal numbers such as first, second, etc. may be used to describe various components, but the components are not limited by the terms. The terms are used only for the purpose of distinguishing one component from another component. For example, without departing from the scope of the present disclosure, a first component may be referred to as a second component, and similarly, a second component may be referred to as a first component.

In the flowcharts described with reference to the drawings in the present specification, the order of operations may be changed, several operations may be merged, certain operations may be divided, and specific operations may not be performed.

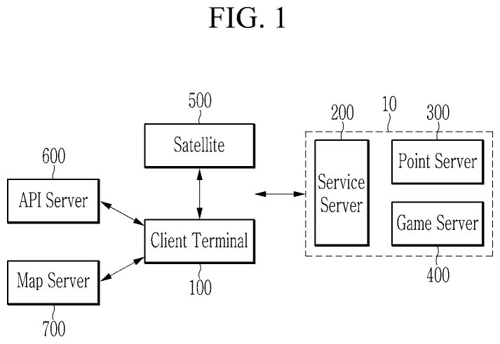

First, as shown in FIG. 1, a user is provided with a user location-based game from an event providing game system 10 through a client terminal 100, and may execute a corresponding event when an event rule is matched.

The client terminal 100 is, for example, a mobile terminal, and may download a necessary client program from the game server 400 and play a target game.

At this time, the client terminal 100 may execute an event matched based on location coordinate values, based on information provided by a pre-stored event table.

The client terminal 100 may receive GPS information via the satellite 500.

Further, the client terminal 100 may utilize GPS information to call the API server 600 and the map server 700, and receive map data including actual environment data and geographical information at a current location.

Through this, the client terminal 100 may reflect actual environment data such as current weather, temperature, humidity, and time in game play, and receive pre-designated place information, that is, point information, as geographical information and reflect the same in game play.

The event providing game system 10 comprises a service server 200, a point server 300, and a game server 400, and may provide an event to the client terminal 100 in a user location-based game.

At this time, the service server 200 may receive and register member information of game service users from the client terminal 100, and perform member management.

When receiving event matching information from the client terminal 100, the point server 300 may check whether the event matching is correct according to a determined rule, and transmit the corresponding event matching information to the game server 400.

Specifically, the point server 300 may check whether the event is based on a predetermined combination value of latitude and longitude in a predetermined time zone, and may set and check participation availability conditions such as whether the event has already been executed at the same point and a number of daily available participations for the event.

The game server 400 may provide a client program for game play in response to a request from the client terminal 100, and may provide player data including a player level, experience, permanent item information, and the like, for starting a game.

In addition, the game server 400 may generate an event table including event rules, and provide the same to the client terminal 100 according to a predetermined cycle.

Meanwhile, the game server 400 may receive event matching information from the point server 300, check previous event progress information of a corresponding user, that is, a participation history, and check whether the user has already completed a corresponding event at the same point.

Alternatively, the game server 400 may set conditions such as a number of daily available participations for each event, and check whether the corresponding terminal corresponds to the participation availability condition.

At this time, according to an embodiment, the game server 400 and the point server 300 may each perform all of the checking of the event participation history or the checking of the event participation availability condition of the client terminal 100, or may distribute and perform the same. Alternatively, according to an embodiment, the point server 300 and the game server 400 may be integrated and implemented as a single server.

The game server 400 may provide event progress information when the corresponding client terminal 100 is able to participate in the corresponding event and an intention to participate is received from the client terminal 100, and may subsequently store event progress content and participation result information for the corresponding user.

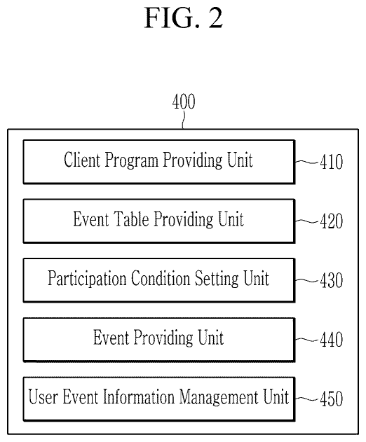

Hereinafter, referring to FIG. 2, the game server 400 according to an aspect of the present invention will be described in more detail.

As shown, the game server 400 may comprise a client program providing unit 410, an event table providing unit 420, a participation condition setting unit 430, an event providing unit 440, and a user event information management unit 450.

The client program providing unit 410 may provide a client program to be downloaded so that the client terminal 100 may communicate with the game server 400, execute a game, and transmit and receive data necessary for game play.

The event table providing unit 420 may generate an event table defining event rules activated at a corresponding location by utilizing a specific location or place on map information, that is, a location coordinate value at a point, or only a location coordinate value itself, in a location-based game.

Specifically, the event rules may be generated in the following manner, and will be described by presenting latitude and longitude values as examples of location coordinate values.
i) In order to generate an event activation rule, first, a range of digits to be utilized among latitude and longitude values may be set.

For example, roles may be defined for each digit in decimal places of latitude and longitude of map coordinates, wherein a first digit of the latitude represents a main location group covering a wide area, and subsequent digits represent a detailed location group covering a relatively detailed area.

Each digit may be defined differently depending on a purpose of use, and up to a 9th decimal place of each of the latitude and the longitude may be utilized depending on settings.
ii) Next, by setting a combination rule for each digit, an event activation location, that is, an event matching coordinate keyword, may be set.

For example, specific digits of the latitude and the longitude may be respectively selected and combined to generate a keyword, and an event occurrence location may be set.

That is, when a specific digit in latitude and longitude coordinate values of a point corresponds to a keyword number of a set event rule, the corresponding point may become an event occurrence location.
iii) In addition, by adding a time coordinate to the event rule, an event occurrence time zone may be controlled. For example, the event occurrence time may be controlled in a manner of activating an event at coordinates corresponding to a specific keyword for every second, minute, or hour.

That is, in the manner described above, the corresponding event may be simultaneously activated and applied at multiple points matching the event rule according to a combination of respective digits of point coordinates and a time variable.

The event rules as described above are defined in the event table, and the event table will be described in detail below with reference to the drawings.

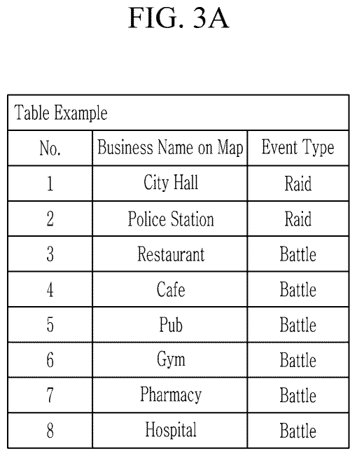

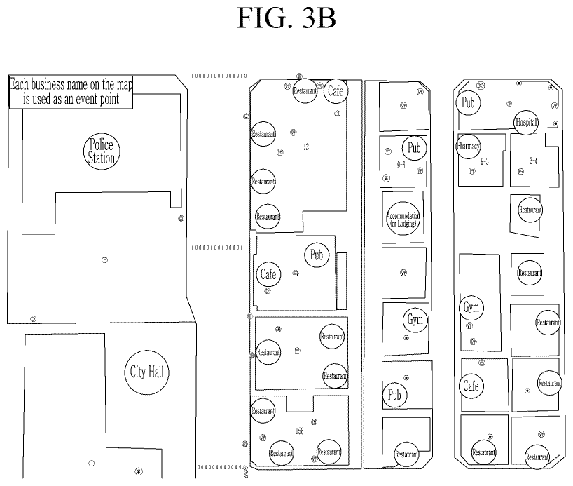

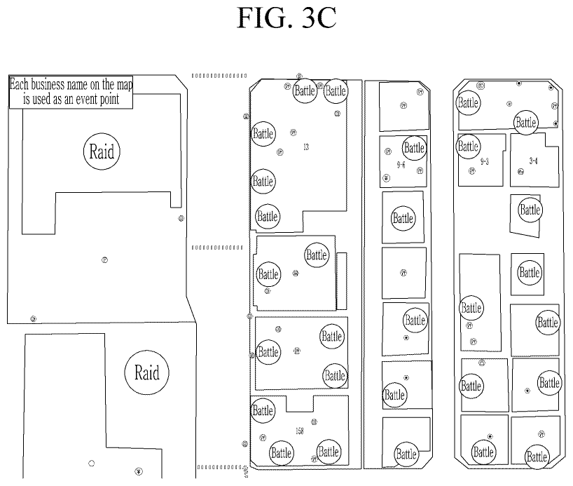

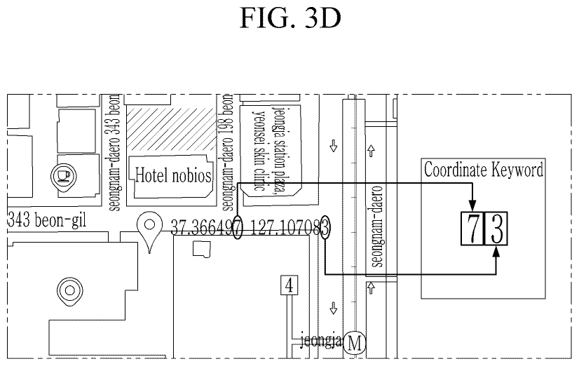

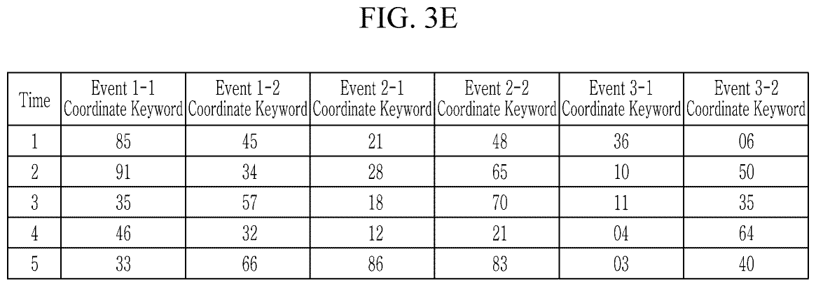

First, as shown in FIG. 3A, the event table may designate points where events are to be generated from among various regions of an actual map, and set an event type to occur at each point.

That is, as shown, for example, when each point is a city hall or a police station, an event type may be predefined as a raid, respectively, and in the case of a restaurant, a cafe, a pub, a gym, a pharmacy, or a hospital, the event type may be predefined as a battle.

More specifically, when name information of each point in geographical information around a user location is as shown in FIG. 3B, an event type for each point may be predefined as shown in FIG. 3C.

At this time, for example, as shown in FIG. 3D, the set new event rule may be to activate the set new event when a combination of digits at a 6th decimal place of the latitude and longitude coordinate values, respectively, corresponds to a coordinate keyword 73.

In addition, regarding a point on the map having latitude/longitude coordinate values of 37.366497/127.107083, since digits at the 6th decimal place in the latitude and longitude coordinate values are 7 and 3, respectively, a result of combining the coordinate values becomes 73, which corresponds to the coordinate keyword 73, and thus a new event may be activated.

FIG. 3E exemplarily illustrates an event table including a time variable and event coordinate keyword information as described above.

That is, at time 1, event 1 may be activated at coordinate keywords 85 and 45, respectively, event 2 may be activated at coordinate keywords 21 and 48, and event 3 may be activated at coordinate keywords 36 and 06.

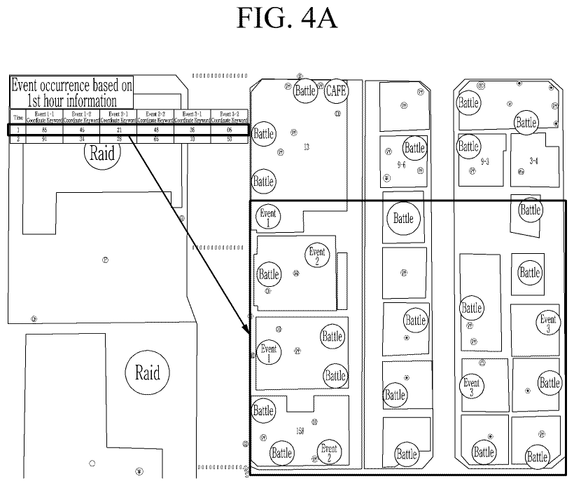

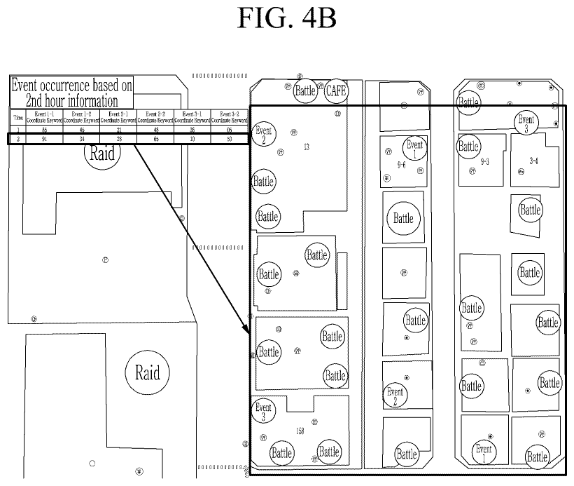

In the same manner, at times 2 to 5, Event 1 to Event 3 may be activated at locations corresponding to coordinate keywords set in the table, respectively. FIG. 4A and FIG. 4B illustrate a new event being activated at a corresponding location according to the event table shown in FIG. 3E.

That is, as shown on the left side of FIG. 4A, the event rule is to combine digits at the 6th decimal place of the latitude and longitude coordinate values, respectively; at time 1, coordinate keywords of Event 1 are set to two types of 85 and 45, coordinate keywords of Event 2 are set to two types of 21 and 48, and coordinate keywords of Event 3 may be set to 36 and 06. At this time, among various points on the map displayed on the right side, each new event may be activated at a location corresponding to the coordinate keyword.

Likewise, as shown on the left side of FIG. 4B, the event rule is to combine digits at the 6th decimal place of the latitude and longitude coordinate values, respectively; at time 2, coordinate keywords of Event 1 are set to two types of 91 and 34, coordinate keywords of Event 2 are set to two types of 28 and 65, and coordinate keywords of Event 3 may be set to two types of 10 and 50.

In addition, among various points on the map displayed on the right side, each event may be activated at a location corresponding to the coordinate keyword.

At this time, as shown in FIG. 4A and FIG. 4B, it can be confirmed that occurrence locations of Events 1 to 3 have changed according to time zones.

Alternatively, the event table providing unit 420 according to an aspect of the present invention may set an event table defining a specific event occurring in an arbitrary area by utilizing all coordinate values on the map regardless of points on the map, and for example, may generate an event table defining an event rule to generate monsters of a desired composition combination at a desired ratio at the corresponding coordinates.

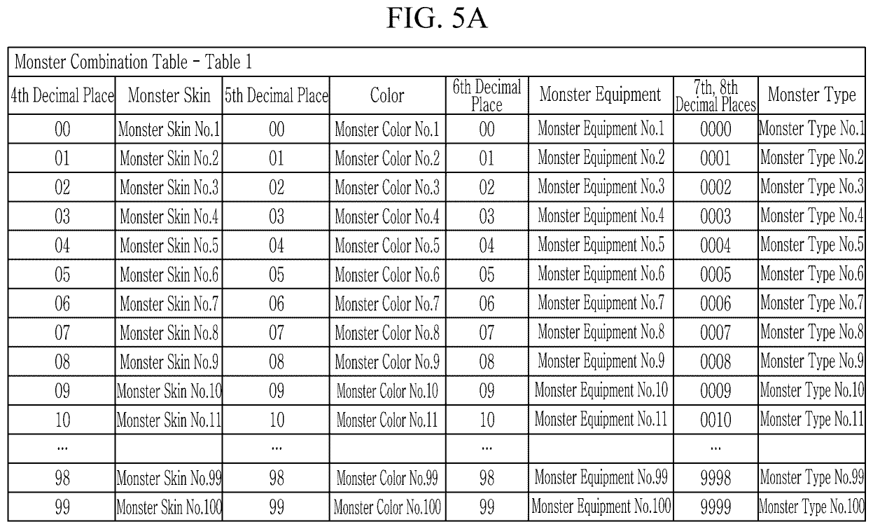

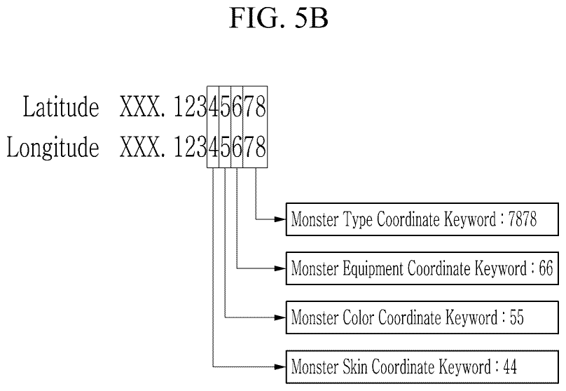

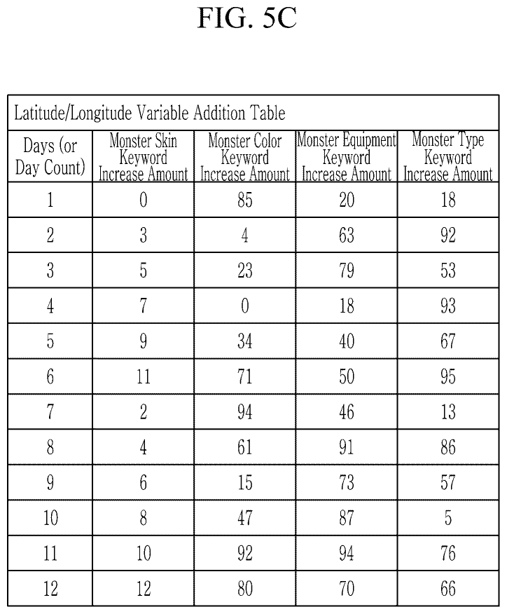

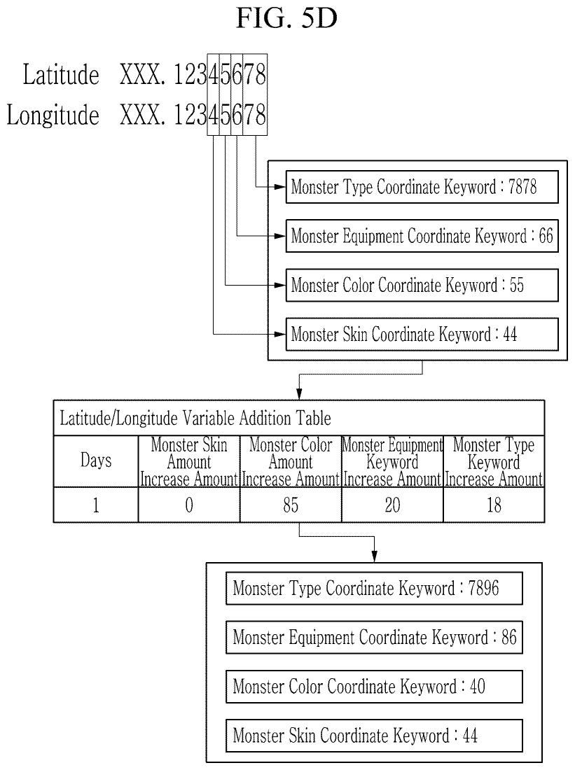

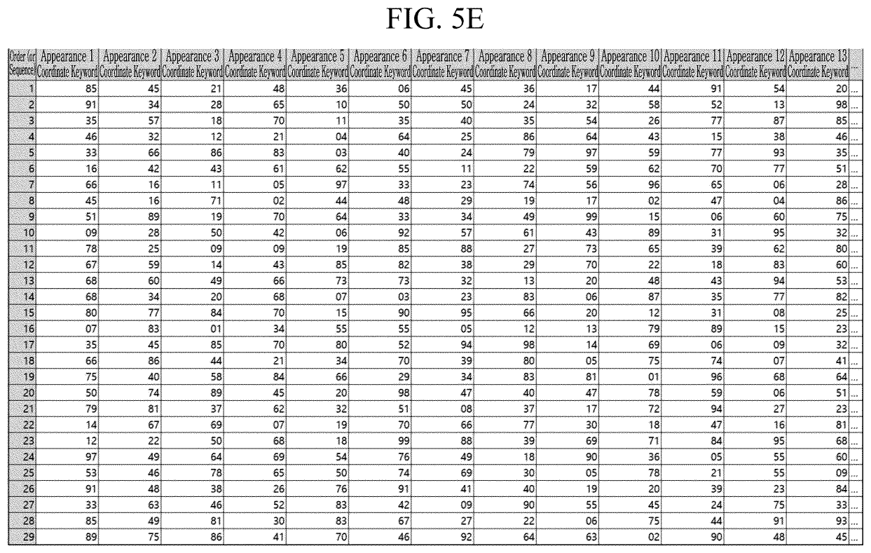

Specifically, as shown in FIG. 5A, the event table may set a skin, a color, equipment, and a type of a monster generated at a specific location on the map.

More specifically, the event table may define a monster skin type according to a result of combining digits at a 4th decimal place from the latitude and longitude values, respectively, define a monster color according to a result of combining digits at a 5th decimal place, define monster equipment according to a result of combining digits at a 6th decimal place, and define a monster type according to a result of combining digits at 7th and 8th decimal places.

For example, as shown in FIG. 5B, when latitude and longitude coordinate values representing a location on a map are xxx.12345678/xxx.12345678, respectively, a coordinate keyword representing a combination of digits at a 4th decimal place in each of the latitude and longitude coordinate values, that is, a monster skin, is 44, a coordinate keyword representing a combination of digits at a 5th decimal place, that is, a monster color, is 55, a coordinate keyword representing a combination of digits at a 6th decimal place, that is, monster equipment, is 66, and a coordinate keyword representing a combination of digits at 7th and 8th decimal places, that is, a monster type, is 7878.

That is, when the client terminal 100 is located at a position on the map where latitude/longitude values are xxx.12345678/xxx.12345678, respectively, a monster having a skin, a color, equipment, and a type corresponding to coordinate keywords 44, 55, 66, and 7878 may appear in the game according to the definition of the event table.

Alternatively, the event table providing unit 420 may vary coordinate keyword values for a skin, a color, equipment, and a type of a monster by providing a variable addition table.

Specifically, as shown in FIG. 5C, the variable addition table may set coordinate keyword increase values for a monster skin, a color, equipment, and a type, for example, by date from a 1st day to a 12th day.

In addition, as shown in FIG. 5D, for example, in the case of a 1st day, when coordinate keyword increase values for the skin, color, equipment, and type are set to 0, 85, 20, and 18, respectively, a monster having a skin, a color, equipment, and a type corresponding to coordinate keywords 44 (44+0=44), 40 (55+85=140), 86 (66+20=86), and 7896 (7878+18=7896) may appear in the game at a location of xxx.12345678/xxx.12345678 according to the event table definition as shown in FIG. 5A.

That is, according to the present invention, diversity and randomness of occurring events may be further enhanced by utilizing the variable addition table. In addition, the event table may define appearance coordinate information of each monster for each time unit.

Specifically, as shown in FIG. 5E, the event table may set coordinates where the monster is to appear, for example, in 30-minute units from sequence 1 to sequence 29, and more specifically, may set a coordinate keyword as a combination of digits at a 7th decimal place in each of latitude and longitude coordinate values.

At this time, when a location of the client terminal corresponds to the corresponding coordinate keyword location, Monster Appearance 1 to 13 events may occur.

For example, in sequence 1, when it is defined that Monster Appearances 1 to 13 occur when a combination of digits at a 7th decimal place in each of latitude and longitude coordinate values, that is, a coordinate keyword, is 85, 45, 21, 48, 36, 06, 45, 36, 17, 44, 91, 54, and 20, respectively, and when a combination of digits at the 7th decimal place in latitude and longitude coordinate values of the client terminal 100 corresponds to one of the coordinate keywords, the corresponding monster appearance may be executed in the game.

According to the present invention, an amount of monster appearances may be controlled by adjusting the number of monster appearance columns in the event table.

Alternatively, the event table providing unit 420 according to an aspect of the present invention may define an event rule to generate an event occurring only in a specific region according to a condition while generating the event randomly at a desired ratio.

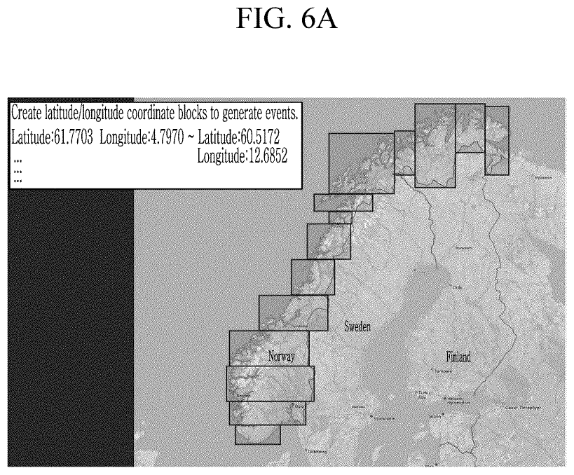

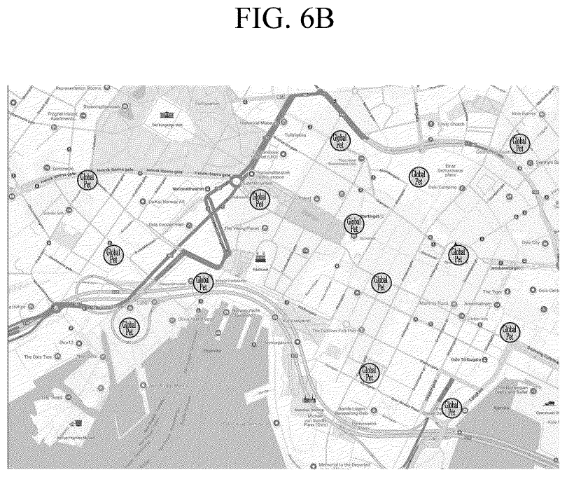

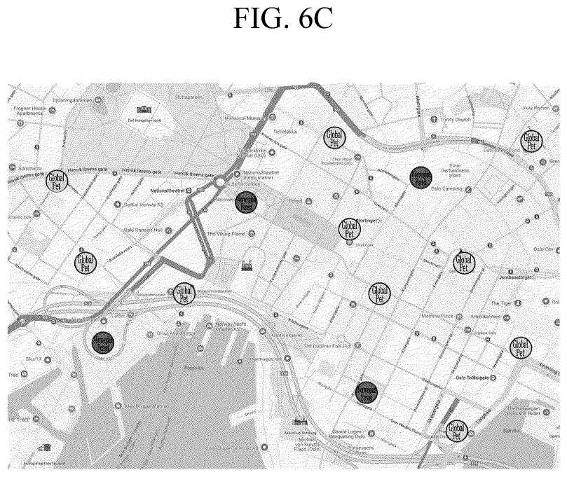

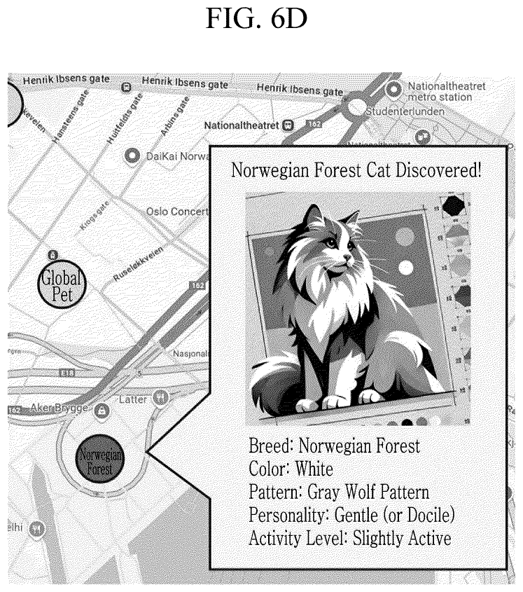

For example, as shown in FIG. 6A, first, a block for latitude and longitude coordinate values where an event is to be generated may be defined; specifically, the corresponding block may be set by utilizing up to a 4th decimal place including digits before a decimal point in the latitude and longitude coordinate values.

At this time, as shown, first, a coordinate block ranging from latitude 61.7703 and longitude 4.7970 to latitude 60.5172 and longitude 12.6852 may be grouped as a specific event occurrence area, which is an area corresponding to a block displayed on a map on the right side of the drawing.

At this time, as shown in FIG. 6B, an event type for each point may be similarly predefined at each point within the corresponding area regardless of a coordinate block setting for generating a specific event, and in the drawing, a global pet event is already defined as an example.

The global pet event may refer to an appearance of a pet that may appear anywhere in the world according to a predetermined rule regardless of a region.

In addition, as described based on FIG. 3E, the event table generation unit 420 may generate an event table defining new specific event occurrence coordinate keywords for each time by a combination of specific digits within the coordinate block.

For example, as shown in FIG. 6C, the event table generation unit 420 may define a coordinate keyword as a combination of digits at a 6th decimal place of latitude and longitude coordinate values within the corresponding coordinate block (that is, a Norway region as shown in FIG. 6A) through the event table, and may define an event rule in which a Norwegian Forest Cat occurring only in the corresponding region appears at a location corresponding to the defined coordinate keyword.

Specifically, as shown in FIG. 6D, an event in which a Norwegian Forest Cat appears may occur.

At this time, the event table may define a Norwegian Forest Cat having different attributes according to a season, weather, time, and temperature of the corresponding region. Specifically, a color, a pattern, a personality, and activity of the Norwegian Forest Cat may be set differently according to a current season, weather, time, and temperature of the corresponding region, respectively.

For example, as shown, within the Norway region corresponding to the coordinate block presented in FIG. 6A, a Norwegian Forest Cat is discovered in an area corresponding to the coordinate keyword defined in the event table, and when the current actual environment of Norway records cloudy weather in October, around 1 p.m., and about 10 degrees Celsius, a Norwegian Forest Cat having a white color including a gray wolf pattern, a gentle personality, and slightly active activity may appear.

Therefore, according to the present invention, since a new specific event is provided at a corresponding location according to a coordinate keyword included in an event table, and at the same time, variability is additionally provided to attributes of the new specific event according to environmental information of a current location in a location-based game, event diversity and randomness may be further expanded.

According to the present invention, when providing content such as a specific event in a game by combining numbers representing coordinate values of a specific location, for example, latitude and longitude values, which are most important in a location-based game, an event with expanded diversity may be provided at a random location appearing to be selected by chance according to a content provision goal.

Referring back to FIG. 2, the participation condition setting unit 430 of the game server 400 may set a participation condition other than event rule matching for each event.

Specifically, the participation condition setting unit 430 may set conditions such as a cumulative number of times participation is possible for the corresponding event for each user and a daily number of times participation is possible for each user.

For example, when a daily number of times participation is possible for a specific event is set to 2 times, even if a location of the client terminal 100 corresponds to a coordinate keyword defined in the event table, when a user has already completed participation in the corresponding event 2 times, the event does not occur in the corresponding client terminal 100.

Alternatively, the participation condition setting unit 430 may set a condition for limiting the number of participants on a first-come, first-served basis by setting the number of available seats for participation for each event.

For example, for an event occurring at a specific point, all users located at the corresponding location may recognize a timing at which participation is possible by the same event table. At this time, the participation condition setting unit 432 may limit available seats for participation for the corresponding event, so that participation of a corresponding user is restricted when all event seats are occupied due to participation of other users even if there is a remaining number of times participation is possible for each user.

The event providing unit 440 may provide new event information to the client terminal 100 when a location of the client terminal 100 corresponds to a coordinate keyword defined in the event table and satisfies a preset participation condition by checking previous event progress information of a corresponding user.

In addition, when a location of the client terminal 100 corresponds to a coordinate keyword defined in the event table, the event providing unit 440 may provide event progress information of other users at the same location together, thereby supporting rapid decision making regarding whether the user participates in the event in a first-come, first-served event.

The user event information management unit 450 may store event progress details and participation result information when a user proceeds with a new event; for example, the user event information management unit 450 may store event progress information such as an event participation record at a corresponding point and a daily number of participations, and reward information acquired by the user through the event.

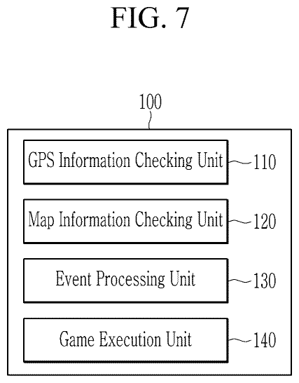

FIG. 7 is a detailed configuration diagram of the client terminal 100 according to an aspect of the present invention.

As shown, the client terminal 100 may include a GPS information checking unit 110, a map information checking unit 120, an event processing unit 130, and a game execution unit 140.

The GPS information checking unit 110 may check current location information of the client terminal 100 through a satellite.

The map information checking unit 120 may request map data of a preset unit area from the map server 700 based on a current location of the client terminal 100, and for example, may receive map data in a 3*3 tile format including geographical information of a region.

The event processing unit 130 may receive and store an event table from the game server 400.

The event processing unit 130 may check an event rule for a corresponding time zone from the event table, combine digits at corresponding positions of the checked current location information value, specifically latitude and longitude coordinate values of the current location, according to a determined event rule, and check whether a combination result corresponds to a coordinate keyword defined in the event table.

The event processing unit 130 may transmit event matching information when a current location corresponds to a coordinate keyword of the event table.

As described above, the game server 400 may finally verify whether the user is a user capable of participating in the corresponding event, and transmit a result to the event processing unit 130.

The event processing unit 130 may receive a request to start a corresponding event from a user and provide the request to the game server 400, and may receive corresponding event progress information from the game server 400 and execute the event. At this time, as described above, the event processing unit 130 may provide predefined variability to an attribute of the event according to environment information of a current location in the location-based game.

The game execution unit 140 may execute location-based game content and process game progress of a user player.

According to the present invention, the client terminal 100 checks whether an event is matched at a current location of each user through an event table previously stored from the game server 400, and since server resources are used from a point in time when an actual event is executed, server load or service operating costs can be significantly reduced.

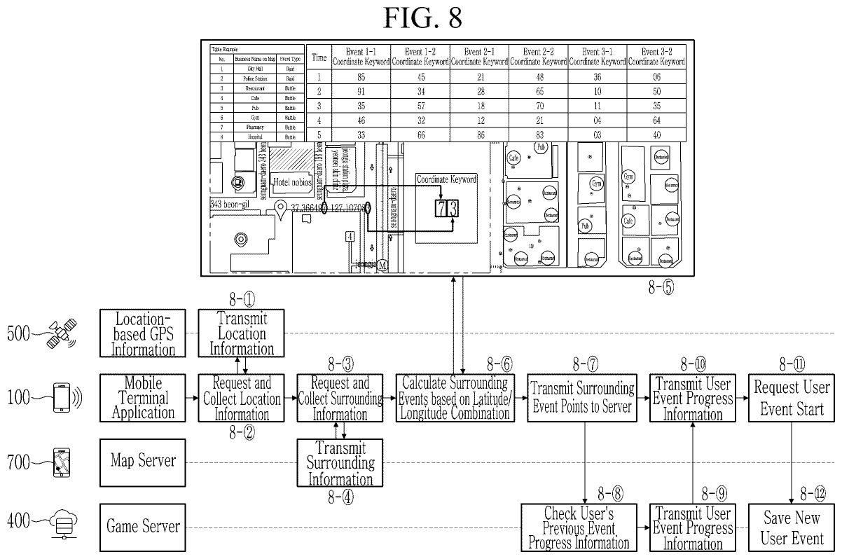

In summary, as shown in FIG. 8, the client terminal 100 may check coordinates of a current location of the client terminal 100, that is, location information, through the satellite 500 (8-\textcircled{1} and 8-\textcircled{2}, and may receive map data including geographical information of a preset unit area centered on the current location from the map server 700 (8-\textcircled{3} and 8-\textcircled{4}).

The client terminal 100 may check an event rule of a corresponding time zone based on an event table (8-\textcircled{5}) received from the game server 400 and previously stored. For example, it may check whether a result corresponds to a coordinate keyword defined in the event table by combining digits at corresponding positions of latitude and longitude coordinate values of a current location according to a determined event rule (8-\textcircled{6}).

The client terminal 100 transmits event matching information to the nearby point server 300 and/or the game server 400, and finally, as described above, the game server 400 checks the user's previous event participation information and may determine whether participation in the corresponding new event is possible (8-\textcircled{7} and 8-\textcircled{8}).

The game server 400 may transmit new event progress information to the client terminal 100 when a request to start the corresponding event is made as a user capable of participating (8-\textcircled{9} and 8-\textcircled{10}).

Meanwhile, as described above, when a location of the client terminal 100 corresponds to a coordinate keyword defined in the event table, the game server 400 may provide event progress information of other users at the same location together to the client terminal 100, thereby assisting rapid decision making regarding whether to participate in the event in a first-come, first-served event.

The client terminal 100 executes the start of a new event, and the game server 400 may store new event progress details and participation result information; for example, it may store event progress information such as an event participation record at the corresponding point and a daily number of participations, and reward information acquired by the user through the event (8-\textcircled{11} and 8-\textcircled{12}).

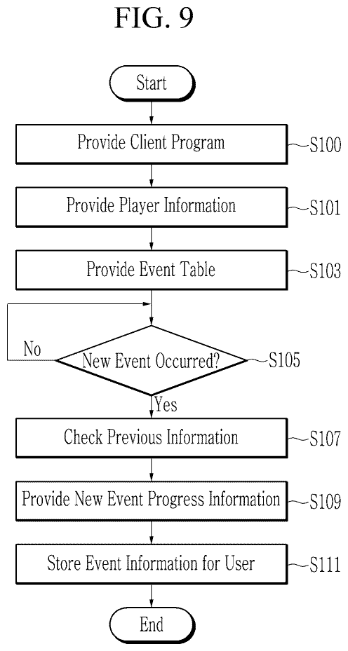

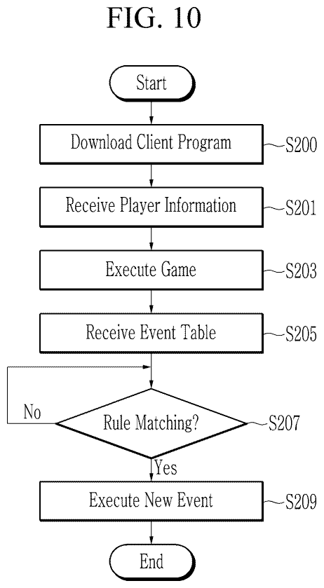

Hereinafter, referring to FIGS. 9 and 10, a method for providing an event based on location coordinate values in the system 10 according to an aspect of the present invention will be summarized and described.

First, as shown in FIG. 9, the system 10 may provide a client program to allow the client terminal 100 to communicate with the system 10, execute a game, and transmit and receive necessary data (S100).

In addition, the system 10 may provide player information such as a player level and items owned by a player to the client terminal 100, and allow a user to execute the game based on the corresponding player information (S101).

Meanwhile, the system 10 may create an event table defining an event rule to be activated at a corresponding location by utilizing a location coordinate value at a specific location or place on map information, that is, a point, or utilizing only a location coordinate value itself, and provide the event table to the client terminal 100 (S103). Since the event table has been described above, a detailed description thereof will be omitted.

The system 10 may receive event matching information from the client terminal 100, and as described above, may determine whether participation in the corresponding new event is possible by checking previous event participation information of the user (S105 and S107).

The system 10 may transmit new event progress information to the client terminal 100 when a request to start the event is made as a user capable of participating in the corresponding event (S109). Meanwhile, as described above, in the case of a first-come, first-served event, the system 10 may provide event progress information of other users at the corresponding location to the client terminal 100.

In addition, the system 10 may store corresponding event progress details and participation result information after the user executes the corresponding event (S111).

Meanwhile, as shown in FIG. 10, the client terminal 100 may first download a client program necessary for game execution and data transmission and reception from the system 10, and may execute the game by receiving player information such as a player level and owned items (S200, S201, and S203).

The client terminal 100 may receive and store the event table described above from the system 10 (S205).

The client terminal 100 may check an event rule of a corresponding time zone based on the event table, and when current location coordinates correspond to a coordinate keyword defined in the event table according to the event rule, the client terminal 100 may receive new event progress information from the system 10 and participate in the corresponding event (S207 and S209).

At this time, as described above, new event progress details and participation result information may be recorded in the system 10.

As described above, according to the present invention, since an event coverage range and an event rule are freely set by utilizing location coordinate values, contingency and randomness of event occurrence can be increased.

In addition, according to the present invention, since event rules are set by utilizing location coordinate values and provided to the client terminal through an event table, event control can be facilitated while diversifying a target area, a regional range, and an occurrence time.

In addition, according to the present invention, since the client terminal checks whether an event is matched based on a previously stored event table, server load can be reduced.

The embodiments of the present disclosure described above are not implemented solely through an apparatus and a method, but may also be implemented through a program that realizes functions corresponding to the configuration of the embodiments of the present disclosure or a recording medium on which the program is recorded.

Although the embodiments of the present disclosure have been described in detail above, the scope of rights of the present disclosure is not limited thereto, and various modifications and improvements by those skilled in the art using the basic concept of the present disclosure defined in the following claims also belong to the scope of rights of the present disclosure.

<Description of symbols>

| | |
|---|---|
| 10: Event providing game system | 100: Client terminal |
| 110: GPS information checking | 120: Map information checking |
| unit | unit |
| 130: Event processing unit | 140: Game execution unit |
| 200: Service server | 300: Point server |
| 400: Game server | 410: Client program providing |
| | unit |
| 420: Event table providing unit | 430: Participation condition |
| | setting unit |
| 440: Event providing unit | 450: User event information |
| | management unit |

1. A location-based event providing game system, comprising:
a service server configured to receive and register member information of game service users from a client terminal to perform member management; and
a game server configured to provide a client program for game play, generate an event table including an event rule, and cause a corresponding event to be executed in the client terminal when matched with the event rule during game execution, wherein the event rule sets a coordinate keyword according to a combination rule between numbers at designated digits of location coordinate values, and generates the corresponding event when a combination result between numbers at designated digits of current location coordinate values of the client terminal matches the set coordinate keyword.

2. The location-based event providing game system of claim 1, wherein the event rule further includes a time variable, and an event matching coordinate keyword is set for each predetermined time zone.

3. The location-based event providing game system of claim 1, wherein the location coordinate values are latitude and longitude values.

4. The location-based event providing game system of claim 3, wherein the game server comprises:
a client program providing unit configured to provide the client program;
an event table providing unit configured to generate an event table defining the event rule;
a participation condition setting unit configured to set event participation availability conditions for users;
an event providing unit configured to provide corresponding event information to cause the event to be executed when a location of the client terminal corresponds to the event matching coordinate keyword and a corresponding user satisfies the event participation availability conditions; and
a user event information management unit configured to store corresponding event progress details and participation result information of the user.

5. The location-based event providing game system of claim 4, wherein the event table providing unit provides the event table to the client terminal at predetermined time intervals to cause the client terminal to store the event table, check the event rule from the stored event table, and determine whether the corresponding event rule is matched.

6. The location-based event providing game system of claim 4, wherein the event participation availability conditions include at least one of a cumulative number of available participations for the corresponding event per user, a daily number of available participations per user, and a number of persons allowed to participate on a first-come, first-served basis per event.

7. An event providing method of a location-based game providing system, comprising:
a) providing a client program for executing a location-based game to a connected client terminal; and
b) generating an event table including an event rule, and causing a corresponding event to be executed in the client terminal when matched with the event rule during game execution,
wherein the event rule sets a coordinate keyword according to a combination rule between numbers at designated digits of location coordinate values, and generates the corresponding event when a combination result between numbers at designated digits of current location coordinate values of the client terminal matches the set coordinate keyword.

8. The event providing method of a location-based game providing system of claim 7, wherein the event rule further includes a time variable, and an event matching coordinate keyword is set for each predetermined time zone.

9. The event providing method of a location-based game providing system of claim 7, wherein the location coordinate values are latitude and longitude values.

10. The event providing method of a location-based game providing system of claim 9, wherein step b) further comprises setting event participation availability conditions for users; and providing corresponding event information to cause the event to be executed when a location of the client terminal corresponds to the event matching coordinate keyword and a corresponding user satisfies the event participation availability conditions.

11. The event providing method of a location-based game providing system of claim 10, wherein the event participation availability conditions include at least one of a cumulative number of available participations for the corresponding event per user, a daily number of available participations per user, and a number of persons allowed to participate on a first-come, first-served basis per event.

12. The event providing method of a location-based game providing system of claim 9, further comprising, after step b), storing corresponding event progress details and participation result information of the user.

13. The event providing method of a location-based game providing system of claim 9, wherein step b) further comprises providing the event table to the client terminal to cause the client terminal to store the event table, check the event rule from the stored event table, and determine whether the corresponding event rule is matched.

14. A computer-readable recording medium storing a program for executing a method for providing an event in a location-based game, the method comprising:
a) storing, by a device, a client program for location-based game play, receiving player information, and executing a game;
b) receiving and storing, by the device, an event table including an event rule from a location-based game system, determining whether the event rule is matched during game execution, and requesting the location-based game system to start an event when matched; and
c) receiving corresponding event progress information from the location-based game system and executing the event,
wherein the event rule sets a coordinate keyword according to a combination rule between numbers at designated digits of location coordinate values, and generates the corresponding event when a combination result between numbers at designated digits of current location coordinate values of the device matches the set coordinate keyword.

15. The computer-readable recording medium of claim 14, wherein the event rule further includes a time variable, and an event matching coordinate keyword is set for each predetermined time zone.

16. The computer-readable recording medium of claim 14, wherein the location coordinate values are latitude and longitude values.
